(19) United States
(12) Patent Application Publication
(10) Pub. No.: US 2023/0417573 A1
(43) Pub. Date: Dec. 28, 2023

(54) Combining Static and Dynamic Map Data

(71) Applicant: Bayerische Motoren Werke Aktiengesellschaft, Muenchen (DE)

(72) Inventor: Andreas Kopp, Hoehenkirchen-Siegertsbrunn (DE)

(21) Appl. No.: 18/250,717

(22) PCT Filed: Oct. 27, 2021
(86) PCT No.: PCT/EP2021/079750

§ 371 Date: Apr. 26, 2023

(30) Foreign Application Priority Data
Dec. 3, 2020 (DE) 10 2020 132 215.1

(51) Int. Cl. G01C 21/00; G01C 21/32

(52) U.S. Cl. CPC G01C 21/387; G01C 21/32

(57) ABSTRACT

A method for determining map data includes acquiring dynamic map data that is referenced to a geographical location, and determining static map data in different versions. Static map data of each version describes a route network in an area of the geographical location. Unique identifiers are assigned to predetermined locations in the static map data. The method also includes determining identifiers which represent a location of the dynamic map data in the different versions of the static map data, and providing the dynamic map data together with corresponding determined identifiers.

The present application is the U.S. national phase of PCT Application PCT/EP2021/079750 filed on Oct. 27, 2021, which claims priority of German patent application No. 10 2020 132 215.1 filed on Dec. 3, 2020, which is incorporated herein by reference in its entirety.

### TECHNICAL FIELD

The disclosure relates to the determination of map data, and in particular, to the combination of dynamic map data with static map data.

### BACKGROUND

Static map data which describe a route network on which the vehicle can be moved are present on board a vehicle. The vehicle can be navigated on the basis of the map data, for example in order to find a favorable route from a current position to a predetermined destination position. If the map data are sufficiently precise, the vehicle can be controlled automatically under certain circumstances.

The static map data are updated at defined intervals. The map data are normally updated with reference to different geographical areas with varying frequency so that the locally available map data can have different versions.

Dynamic map data relate, for example, to events such as roadworks, an area affected by bad weather or a road traffic accident, and can possibly be relevant to the navigation or route planning of the vehicle. Such data are normally transmitted to the vehicle on a path that differs from that of the static map data. The dynamic map data are normally up-to-date to within minutes or hours, whereas static map data can be up-to-date to within days, months or years.

The static map data are normally expressed as geodetic data in relation to a predetermined geoid. Conversely, dynamic map data normally relate to locations which are defined only by static map data, for example a predetermined section of a road. Combining the dynamic and static information is normally ambiguous in many cases, is not always error-free and is generally loss-affected. Compilation methods can be correspondingly complex so that the processing capacity on board the vehicle can be exceeded.

### SUMMARY

An underlying object of the present disclosure includes providing an improved technique for providing map data on board a vehicle. This object is achieved by at least some embodiment described herein.

A first aspect is a first method for determining map data that includes steps of: acquiring dynamic map data which are referenced to a geographical location; determining static map data in different versions, wherein static map data of each version describe a route network in the area of the location, wherein a unique identifier is assigned to predetermined locations in static map data of each version; determining identifiers which represent the location of the dynamic map data in the different versions of the static map data; and providing the dynamic map data together with the corresponding identifiers.

According to some embodiments, unique references between the dynamic map data and the static map data can be determined for each present version of the static map data. If a reference is not creatable, for example because a link to which predetermined dynamic map data relate does not exist in a version of static map data, this dynamic map data can be rejected for the present version. An only partial reference can be established if the dynamic map data relate only partially to elements not known in a version. The determination of the references can also be referred to as cross map referencing or location rereferencing. The references can be applied directly to existing static map data without requiring further adaptation.

According to one or more embodiments, the references to all static map data can be produced centrally. A sufficiently dimensioned processing device can be provided for this purpose. If dynamic map data are required at a different location, they can be provided in a form that is already suitable for static map data present there. The references do not have to be created by the different location. The overall processing effort required for the reference formation can be reduced. Processing speed can be increased, in particular in respect of the different location.

The dynamic map data can comprise, in particular, an event which can at least temporarily influence the navigability of the route network. In terms of time, a start, a duration and/or an end of the event can be indicated. The event can be related locally to a predetermined position, a predetermined route, a predetermined section of a route or a predetermined area. Dynamic map data can comprise geodetic location details, for example in the form of a degree of longitude and latitude. Data referring to a specified route or point on the route network can also be used. Roads in towns, for example, can have a name, and roads outside towns can have a number. A point on a road can be indicated in towns by means of a house number, and outside towns by means of a distance from a town to which the road leads. In addition, the dynamic map data can comprise further information in order to simplify or clarify a referencing to the static map data, e.g. a road type or a road class, an angle of curvature on a turning or a road length. However, the dynamic map data are not referenced to a specific map or to static map data, in particular in a specific version. Above all, no identifiers are therefore provided which indicate locations in a version of static map data. A format of this type is also referred to as map-independent or map-agnostic. An event can be referenced by means of one or more identifiers.

In one embodiment, a request for dynamic map data relating to a predetermined version of static map data is recorded; and the requested dynamic map data and the identifier(s) determined in relation to the predetermined version are provided. In this embodiment, the different location can indicate the version of existing static map data for which the dynamic map data are required. The dynamic map data can exclusively comprise references to the requested versions, so that a response to the request can be formulated quickly and succinctly.

If the predetermined version in relation to which the dynamic map data are requested is not included in the versions of the determined static map data, the requested dynamic map data can be provided together with an indicator which is determined in relation to the next-oldest version of static map data. In other words, an attempt can be made to provide dynamic map data with at least partially matching identifiers.

In a further embodiment, a request for dynamic map data is recorded; and the requested dynamic map data and identifiers determined in relation to a plurality of versions of the static map data are provided. A version of static map data which is available to the requesting party can be irrelevant. Due to the plurality of indicators, the requesting party can himself decide which of these he uses. References to an underlying version of the static map data are preferably attached in each case to the provided identifiers.

The request can relate to dynamic map data which are located within a predetermined geographical area. A request normally relates to a predetermined geographical area which can be indicated, for example, as one or more tiles of a map. Static map data of individual tiles can be updated independently from one another under certain conditions, for example if an update relates to no objects which span adjoining tiles. A response to a request can comprise one or more events.

If static map data are acquired in a new version, identifiers for existing dynamic map data can be determined in relation to the new version. Particularly if the identifiers are managed at a central location and a new version of static map data becomes known, the dynamic map data can be referenced to the new version. Identifiers which may be required for the subsequent response to a request relating to the new version can thus be predictively determined.

According to a further aspect, a second method for determining map data includes steps of: determining a version of locally available static map data, wherein the static map data describe a route network and a unique identifier is assigned in each case to predetermined locations in the route network; requesting dynamic map data relating to the determined version; and receiving dynamic map data and identifiers assigned to the dynamic map data.

The second method can be carried out, by way of example, by a vehicle or a different device which manages static map data locally and retrieves dynamic map data from an external location. The dynamic map data can be provided by means of the first method described herein and can be referenced by means of identifiers.

The dynamic map data can be integrated with the static map data. This step is preferably carried out by the aforementioned device, in particular by a vehicle. The vehicle can be navigated or controlled, for example, on the basis of the integrated map data. In particular, a route on the route map can be determined on the basis of the static and the dynamic map data.

According to another further aspect, a first device for determining map data includes a first data memory for dynamic map data which are referenced to a geographical location; a second data memory for static map data in different versions, wherein static map data of each version describe a route network in the area of the location, wherein a unique identifier is assigned in each case to predetermined locations in the route network of a version; and a processing device. The processing device is configured to determine identifiers which represent a location of dynamic map data in the static map data of the different versions, and to provide dynamic map data together with determined identifiers.

The first device and, in particular, its processing device, can be configured to carry out a first method described herein. To do this, the processing device can comprise a programmable microcomputer or microcontroller, and the first method can be present in the form of a computer program product with program code means. The computer program product can also be stored on a computer-readable data medium. Features or advantages of the first method can be transferred to the first device or vice versa.

According to another further aspect, a second device for determining map data includes a data memory for static map data in a version, wherein the static map data describe a route network and a unique identifier is assigned in each case to predetermined locations in the route network; and a communication device for requesting dynamic map data relating to the determined version; and for receiving dynamic map data and identifiers assigned to the dynamic map data.

The second device and, in particular, its processing device, can be configured, in particular, to carry out a second method described herein. To do this, the processing device can comprise a programmable microcomputer or microcontroller, and the first method can be present in the form of a computer program product with program code means. The computer program product can also be stored on a computer-readable data medium. Features or advantages of the second method can be transferred to the second device or vice versa.

According to another further aspect, a system comprises a first device described herein and a second device described herein. The devices can be interconnected by means of a network. The network can be designed as a wireless network. In particular, the network can comprise a mobile network or the Internet.

The second device can further comprise a processing device which is configured to integrate the dynamic map data with the static map data.

According to a further aspect, a vehicle comprises a second device described herein.

The above-described features and embodiments will become more readily apparent to those of ordinary skill in the art by reference to the following detailed description and accompanying drawings.

### BRIEF DESCRIPTION OF THE DRAWINGS

FIG. 1 shows a schematic block diagram of a system according to a first embodiment;

FIG. 2a shows a representative diagram of a first example of static and dynamic map data;

FIG. 2b shows a representative diagram of a second example of static and dynamic map data;

FIG. 3 shows a flow diagram of a method according to an embodiment.

### DETAILED DESCRIPTION

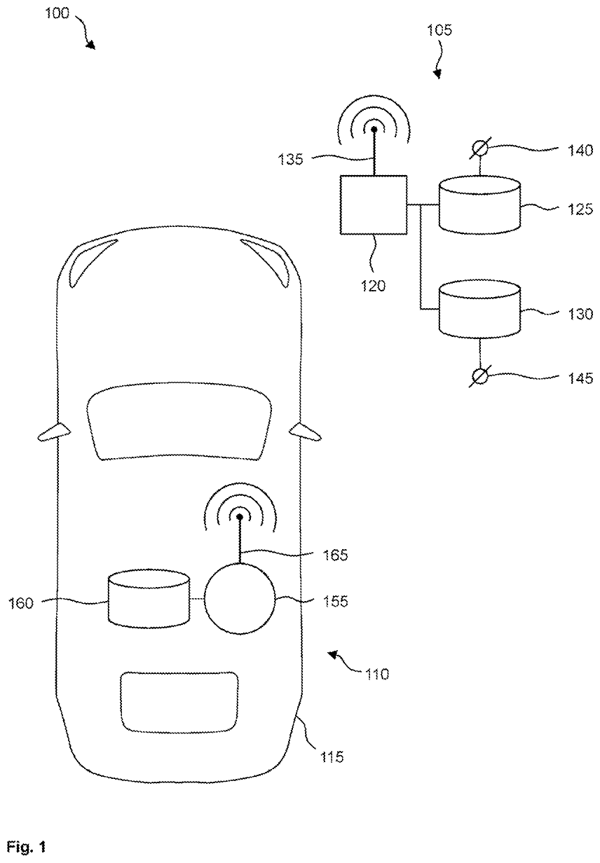

FIG. 1 shows a system 100 which comprises a first device 105 and a second device 110. The first device 105 can be implemented, for example, as a server or service, in particular in a cloud, and the second device 110 is preferably fitted on board a vehicle 115, in particular a motor vehicle. The system 100 can comprise any number of second devices 110 which can be fitted on board different vehicles 115.

The first device 105 preferably comprises a processing device 120, a first data memory 125 for dynamic map data, a second data memory 130 for static map data and a communication device 135. A first interface 140 and/or a second interface 145 can further be provided. The first interface 140 is configured to enable changes to dynamic map data which are stored in the first data memory 125.

Dynamic map data can be added, modified and/or deleted. Dynamic map data can, for example, also be added or removed automatically in a time-controlled manner. Dynamic map information can originate from different sources, for example the TMC system, satellite observations or static traffic counting devices. It is preferable for the dynamic map data to be stored in a map-agnostic format, i.e. without direct reference to a specific map or specific static map data. The dynamic map data can comprise, for example, geodetic data or a reference to a traffic-related device such as a traffic node or a link between traffic nodes. Further information which is not referenced to a map can similarly be included.

The second interface 145 is configured to enable changes to static map data which are stored in the second data memory 130. Static map data are normally provided by one or more map manufacturers (providers) and can be fused or synchronized with one another.

As will be shown in more detail later, static map data are not normally overwritten or deleted if revised or new static map data are received. Instead, existing static map data can be retained and incoming static map data can be referenced to a new version. An archive of static map data than thus be created in different versions over time. The static map data are normally organized in tiles (also referred to as map tiles) which in each case cover a predetermined area, for example approximately 2.4 km*2.4 km. Tiles of different sizes can be provided which can comprise data of varying precision or detail. A larger tile can partially or completely cover one or more smaller tiles. Map data of a single tile are normally updated so that the previously valid tile is available as static map data of a first version, and the updated information is available as static map data of a second version.

Map data of a predetermined version do not necessarily have to cover a predetermined area completely. If a map tile is missing for a predetermined version, an existing map tile of the next-smallest version applies in its place.

The processing device 120 is preferably configured to relate dynamic map information to all existing versions of static map tiles and, for this purpose, in each case to form one or more identifiers which map the dynamic map information onto locations of the static map information. The identifiers in each case indicate a location on the route network of static map information of a predetermined version. One or more identifiers can therefore be assigned to dynamic map information which, for example, represents an event, for each version of static map data present in the second data memory 130. If dynamic map information is revised, identifiers adapted for all existing versions of static map data can be provided. If dynamic map information is deleted or added, corresponding operations can be carried out in relation to the known versions of static map information.

The second device 110 comprises a processing device 155, a data memory 160 for storing static map data, and a communication device 165 for communicating with the first device 105 or its communication device 135. The stored static map data relate to a predetermined version. If the static map data are subdivided into subunits, for example tiles, the subunits can carry different versions. The locally available static map data can be updated, for example by means of the first device 105. Static map data between the first device 105 and the second device 110 are identical if they carry the same version.

For working with map data, the locally available static map information can be integrated or interlocked with dynamic map information which can be requested from the first device 105. If dynamic map information, for example, within a predetermined radius around the current, known position of the vehicle 115 is of interest, the tiles which cover the area in question and the versions which the tiles have can be determined. A request relating to the determined tiles and their versions can then be made to the first device 105. A response from the first device 105 comprises dynamic map data in the determined area which are referenced in each case by means of one or more identifiers to locations which are indicated in the static map data of the available versions.

The second device 110 can easily integrate the dynamic map information and static map information with one another and can determine a route or control the vehicle 115 on the basis of the event.

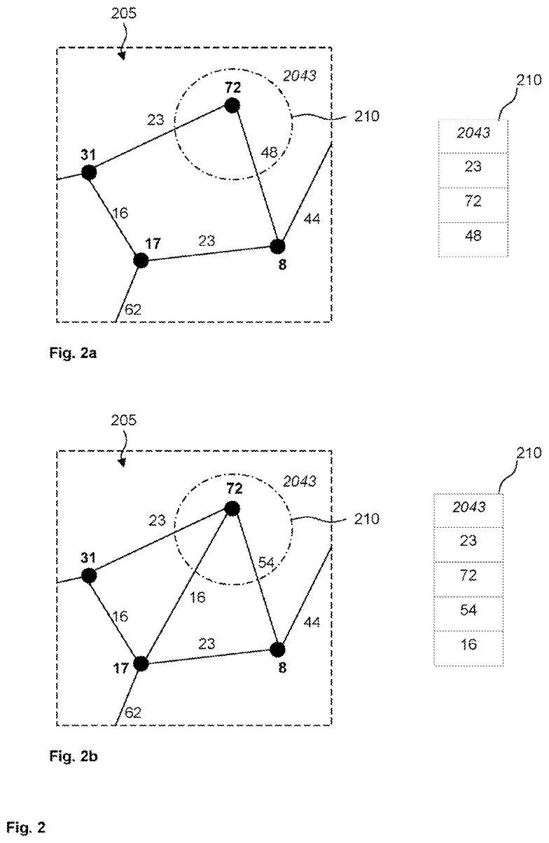

FIGS. 2a and 2b show examples of map data which in each case comprise static map data 205 and dynamic map data 210. FIG. 2a relates to static map data 205 in a first version and FIG. 2b relates to static map data 205 in a later, second version. The static map data 205 comprise nodes which are shown as dark circles with emboldened identifiers, and edges which are shown as links between nodes and with italicized identifiers. The identifiers are chosen purely by way of example. In practice, identifiers are normally defined by a provider of a digital map. An identifier can relate to a point, a route or an area.

An additional link between the nodes 17 and 72 is provided in the static map data shown in FIG. 2b compared with the version shown in FIG. 2a. The link between the nodes 72 and 8 is further renumbered from 48 to 54. In practice, it may occur that virtually all identifiers are changed between two versions of static map data.

A non-graphical representation of dynamic map data 210 is shown in each case in a right-hand area of the figures. The top entry shown can comprise an identifier or a descriptor of an event. The identifier can be unique among all used identifiers of dynamic map data 210. The descriptor can indicate the type of event concerned, for example a weather warning, a road traffic accident or traffic congestion. Identifiers following below it relate to edges or nodes of the respective static map data 205.

The static identifiers can be interpreted as a point, route or area. Two identifiers, for example, can define ends of a route on a link on the route network of the static map data 210. A circular area on the static map data 210 is affected here by way of example.

It is evident that dynamic map data 210 of a predetermined event can have completely different identifiers for referencing different versions of static map data 205.

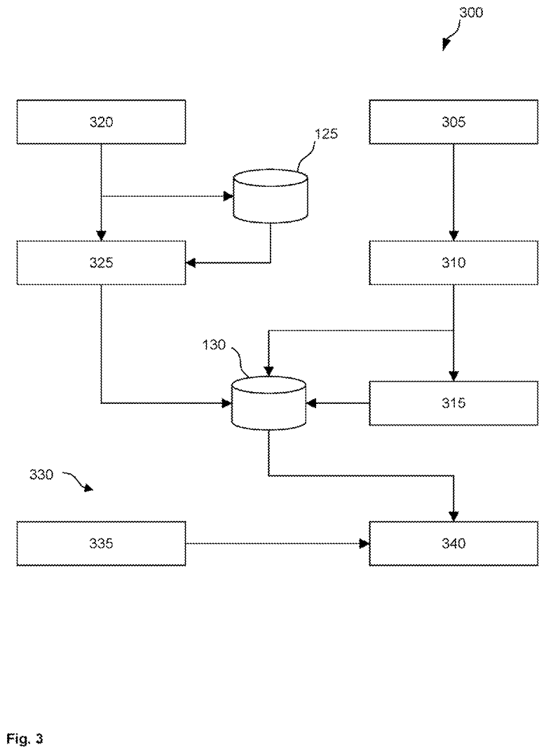

FIG. 3 shows a flow diagram of a first method 300 and a second method 330. The first method 300 can be carried out, in particular, by means of a first device 105 and the second method 330 by means of a second device 115. The methods 300, 330 can also be integrated with one another to form one method.

In a step 305, an update arrives of static map data 205 which are available in the first device 105, for example in the second data memory 130, for example via the second interface 130. The update can be instigated, for example, by a publication of map data by a map producer.

In a step 310, a new version of static map data 205 can be formed for the update. Previously up-to-date static map data 205 are preferably not deleted, but instead are retained. The updated and the retained static map data 205 can be stored as different versions in the second data memory 130.

In a step 315, one or more identifiers relating to the new version of the static map data 205 are determined in each case for relevant dynamic map data 210. The determined identifiers can be stored together with the respectively assigned dynamic map data 210 in the first data memory 125.

In a step 320, independently from steps 305 to 315, an update of dynamic map data 210 can arrive at the first device 105, for example via the first interface 140. The update can be performed on the dynamic map data 210 stored in the first data memory 125, for example by adding dynamic map data 210 or modifying or deleting existing dynamic map data 210. The dynamic map data 210 stored in the first data memory 125 always comprise events that are currently valid or will be valid in the predetermined future. Historical events which no longer prevail are not normally retained, or are at least no longer used for the technology proposed herein.

In a step 325, identifiers for all updated dynamic map data 210 can be revised or recreated. For this purpose, identifiers relating to all existing static map data 205 are preferably determined. Out-of-date identifiers are discarded, and new identifiers are stored in a suitable form, for example in the first data memory 125.

The second method 330 is linked to the first method 300 via the static and dynamic map data 205, 210 in the data memories 125, 130. The second method 330 can be carried out, for example, by a second device 110, in particular on board a vehicle 115.

In a step 335, a request for the provision of dynamic map data 210 can be determined and transmitted to the first device 105. The request can comprise a reference to a geographical territory or an area in which dynamic map data 210 are required. A reference to a version of static map data 205 which are available in the second device 110 can further be provided. If the desired territory comprises segments with different versions of static map data 205, a plurality of references can be provided accordingly. The references can relate, for example, to predetermined tiles of a map.

In a step 340, a response to the request can be provided by the first device 105. For this purpose, predetermined identifiers relating to the indicated version of existing static map data 205 can preferably be selected and made available together with a descriptor of the valid dynamic map data 210. The provided response can be transmitted to the second device 110. The received dynamic map data 205 can be referenced there directly to the locally available static map data 210 so that easily integrated map data can be provided which can be used, for example, for navigation or route planning.

### REFERENCE SIGNS

100 System
105 First device
110 Second device
115 Vehicle
120 Processing device
125 First data memory (dynamic map data)
130 Second data memory (static map data)
135 Communication device
140 First interface
145 Second interface
155 Processing device
160 Data memory
165 Communication device
205 Static map data
210 Dynamic map data
300 First method
305 Update static map data
310 Form new version
315 Form identifiers for new version
320 Update dynamic map data
325 Form identifiers for all versions
330 Second method
335 Request
340 Provide response

1.-13. (canceled)

14. A method for determining map data, comprising:
acquiring dynamic map data that is referenced to a geographical location;
determining static map data in different versions,
wherein static map data of each version describe a route network in an area of the geographical location,
wherein unique identifiers are assigned to predetermined locations in the static map data;
determining identifiers which represent a location of the dynamic map data in the different versions of the static map data; and
providing the dynamic map data together with corresponding determined identifiers.

15. The method as claimed in claim 14, further comprising:
receiving a request for dynamic map data relating to a predetermined version of static map data; and
providing the requested dynamic map data and the identifier determined in relation to the predetermined version.

16. The method as claimed in claim 15, the request includes information identifying the predetermined version of the static map data.

17. The method as claimed in claim 15, wherein the predetermined version is not included in the different versions of the determined static map data; and the requested dynamic map data is provided together with an indicator which is determined in relation to a next-oldest version of static map data.

18. The method as claimed in claim 14, further comprising:
receiving a request for dynamic map data; and
providing the requested dynamic map data and identifiers determined in relation to a plurality of versions of the static map data.

19. The method as claimed in claim 18, wherein the request relates to dynamic map data which correspond to locations within a predetermined geographical area.

20. The method as claimed in claim 14, wherein a new version of static map data is acquired, and identifiers for existing dynamic map data are determined in relation to the new version of the static map data.

21. The method of claim 20, wherein the new version of the static map data and a prior version of the static map data are stored in at least one memory.

22. A method for determining map data, wherein the method comprises the following steps:
determining a version of locally available static map data,
wherein the static map data describe a route network and a unique identifier is assigned in each case to each of a set of predetermined locations in the route network;
requesting dynamic map data relating to the determined version; and
receiving dynamic map data and identifiers assigned to the dynamic map data.

23. The method as claimed in claim 22, wherein the dynamic map data is integrated with the static map data.

24. The method as claimed in claim 22, further comprising determining a route on the route network on the basis of the static map data and the dynamic map data.

25. The method as claimed in claim 22, wherein requesting the dynamic map data further comprises using a communication device to request the dynamic map data.

26. The method as claimed in claim 25, further comprising determining a route on the route network on the basis of the static map data and the dynamic map data.

27. A device for determining map data, wherein the device comprises:
a first data memory for dynamic map data which are referenced to a geographical location;
a second data memory for static map data in different versions,
wherein static map data of each version describes a route network in the area of the geographical location,
wherein a unique identifier is assigned in each case to predetermined locations in the route network of a version;
a processing device which is configured to determine identifiers which represent a location of dynamic map data in the static map data of the different versions; and
to provide dynamic map data together with the determined identifiers.

28. A device for determining map data, wherein the device comprises:
a data memory for static map data in a version,
wherein the static map data describe a route network and a unique identifier is assigned in each case to predetermined locations in the route network;
a communication device configured to request dynamic map data relating to the version;
and to receive dynamic map data and identifiers assigned to the dynamic map data.

29. The device as claimed in claim 28, further comprising a processing device which is configured to integrate the dynamic map data with the static map data.

30. A vehicle, comprising a device as claimed in claim 29.

31. A vehicle, comprising a device as claimed in claim 28.
